(19) United States
(12) Patent Application Publication
(10) Pub. No.: US 2016/0005358 A1
(43) Pub. Date: Jan. 7, 2016

(54) DRIVING METHOD, DRIVING APPARATUS, AND ORGANIC LIGHT EMITTING DISPLAY

(71) Applicant: BOE Technology Group Co., Ltd., Beijing (CN)

(72) Inventor: Ying Wang, Beijing (CN)

(21) Appl. No.: 14/553,224

(22) Filed: Nov. 25, 2014

(30) Foreign Application Priority Data
Jul. 1, 2014 (CN) 201410310568.3

(51) Int. Cl. G09G 3/32

(52) U.S. Cl. CPC G09G 3/3233; G09G 3/3258; G09G 2320/0223; G09G 2310/0262; G09G 2330/028

(57) ABSTRACT

The present disclosure discloses a method and apparatus for driving an organic light emitting display and an organic light emitting display. In embodiments of the present disclosure, when a respective current signal input from each power signal line to a respective pixel circuit exceeds a preset current threshold, voltage attenuation on the power signal line can be compensated by applying a compensation signal to the respective pixel circuit connected to the power signal line, thereby improving uniformity of display images of the organic light emitting display and enhancing quality of display images of the organic light emitting display.

### TECHNICAL FIELD

Embodiments of a present disclosure relate to a field of display, and more particularly, to a method and apparatus for driving an organic light emitting display and an organic light emitting display.

### BACKGROUND

Organic Light Emitting Displays (OLEDs) are popular in the field of display.

The OLEDs may be divided into a passive driving device and an active driving device according to a driving manner, which correspond to direct addressing and Thin Film Transistor (TFT) matrix addressing respectively. The active driving device is also referred as an Active Matrix (AM). Each light emitting unit in an AM-OLED is independently controlled by a TFT addressing circuit. A pixel circuit composed of a light emitting unit and a TFT addressing circuit is driven by loading a power voltage signal such as a VDD signal via a power signal line. As the AM-OLED is a current mode device, luminance is proportional to a driving current, and is in an exponential relationship with a driving voltage signal. Therefore, in a state of display an image with a low grayscale, a change in the luminance of light emitted by the AM-OLED is sensitive to a change in the VDD signal on the power signal line. In the AM-OLED, voltage attenuation on the power signal line will result in a change in the VDD signal, thereby influencing uniformity of the display.

Conventionally, in order to reduce voltage attenuation on the power signal lines so as to improve a quality of display images, there are many manners for wiring power signal lines in an AM-OLED panel. FIG. 1 illustrates a wiring manner. As shown in FIG. 1, power signal lines 1 corresponding to pixel circuits are arranged in gaps among the columns of pixel circuits (not shown) and gaps among various rows of pixel circuits of an active display area of the display panel, and a circle of closed peripheral power signal line 1 is arranged outside the active display area of the panel. The power signal lines 1 among the columns of pixel circuits and the power signal lines 1 among the rows of pixel circuits intersect to form a grid structure, and are integrated with the peripheral power signal line 1 outside the active display area, so as to respectively transfer a VDD signal from a signal source Integrated Chip (IC) 2 to respective pixel circuits connected to the power signal lines through these power signal lines 1.

When the conventional manner of wiring power signal lines is used for a small-sized AM-OLED, it may effectively improve the influence of the voltage attenuation on the power signal lines on the display effect. However, as the size of the AM-OLED increases, the conventional manner of wiring power signal lines cannot effectively solve the influence of the voltage attenuation on the display effect.

### SUMMARY

Embodiments of the present disclosure provide a method and apparatus for driving an organic light emitting display and an organic light emitting display, to improve non-uniformity of display images of the organic light emitting display due to voltage attenuation on power signal lines, thereby enhancing quality of display images of the organic light emitting display

In an embodiment of the present disclosure, a method for driving an organic light emitting display is provided, comprising:

acquiring current signals input from various power signal lines in an active display area of the organic light emitting display to respective pixel circuits connected to the power signal lines;

determining whether a difference between a preset reference current signal and each of the acquired current signals input from the power signal lines to respective pixel circuits connected to the power signal lines is greater than a preset current threshold;

if the difference between the preset reference current signal and the acquired current signal is greater than the preset current threshold, generating a compensation signal corresponding to the power signal line according to the difference; and

applying the compensation signal to a respective pixel circuit connected to the power signal line.

In the above method according to an embodiment of the present disclosure, when a respective current signal input from each power signal line to a respective pixel circuit exceeds a preset current threshold, voltage attenuation on the power signal line can be compensated by applying a compensation signal to the respective pixel circuit connected to the power signal line, thereby improving uniformity of display images of the organic light emitting display and enhancing quality of display images of the organic light emitting display.

Preferably, determining whether a difference between a preset reference current signal and each of the acquired current signals input from the power signal lines to respective pixel circuits connected to the power signal lines is greater than a preset current threshold may comprise:

converting each of the acquired current signals input from the power signal lines to respective pixel circuits connected to the power signal lines into a voltage signal; and

determining whether a difference between a preset reference voltage signal and the voltage signal is greater than a preset voltage threshold.

Preferably, determining whether a difference between a preset reference voltage signal and the voltage signal is greater than a preset voltage threshold may comprise:

converting the voltage signal into a digital signal; and

determining whether a difference between a preset reference digital signal and the digital signal is greater than a preset digital signal threshold.

Preferably, the method further comprises: after determining whether the difference between the preset reference voltage signal and the voltage signal is greater than the preset voltage threshold,

converting the difference between the preset reference voltage signal and the voltage signal into a digital signal.

Preferably, generating a compensation signal corresponding to the power signal line according to the difference may comprise:

selecting a compensation signal corresponding to the difference from a pre-stored compensation signal mapping relationship table.

Preferably, acquiring current signals input from the power signal lines in an active display area of the organic light emitting display to respective pixel circuits connected to the power signal lines may comprise:

when the organic light emitting display is started and/or in an interval between display of two frames of images on the organic light emitting display, acquiring the current signals input from the power signal lines in the active display area of the organic light emitting display to respective pixel circuits connected to the power signal lines.

In an embodiment of the present disclosure, an apparatus for driving an organic light emitting display is provided, comprising:

an acquisition unit configured to acquire current signals input from various power signal lines in an active display area of the organic light emitting display to respective pixel circuits connected to the power signal lines;

a processing unit configured to determine whether a difference between a preset reference current signal and each of the acquired current signals input from various power signal lines to respective pixel circuits connected to the power signal lines is greater than a preset current threshold;

a compensation signal generation unit configured to generate a compensation signal corresponding to the power signal line according to the difference if the difference between the preset reference current signal and the current signal is greater than the preset current threshold; and

a transmission unit configured to apply the compensation signal to a respective pixel circuit connected to the power signal line.

Preferably, the processing unit may comprise:

a voltage conversion unit configured to convert each of the acquired current signals input from various power signal lines to respective pixel circuits connected to the power signal lines into a voltage signal; and

a determination unit configured to determine whether a difference between a preset reference voltage signal and the voltage signal is greater than a preset voltage threshold.

Preferably, the determination unit may comprise:

a first analog-digital conversion unit configured to convert the voltage signal into a digital signal; and

a determination sub-unit configured to determine whether a difference between a preset reference digital signal and the digital signal is greater than a preset digital signal threshold.

Preferably, the processing unit may further comprise:

a second analog-digital conversion unit configured to convert the difference between the preset reference voltage signal and the voltage signal into a digital signal when it is determined that the difference between the preset reference voltage signal and the voltage signal is greater than the preset voltage threshold.

Preferably, the compensation signal generation unit is configured to:

select a compensation signal corresponding to the difference from a pre-stored compensation signal mapping relationship table.

In an embodiment of the present disclosure, an organic light emitting display is provided, comprising any said apparatus according to an embodiment of the present disclosure.

### BRIEF DESCRIPTION OF THE DRAWINGS

FIG. 1 is a diagram of a wiring structure of power signal lines in a conventional AM-OLED;

FIG. 2 is a flowchart of a method for driving an organic light emitting display according to an embodiment of the present disclosure;

FIG. 3 is a structural diagram of an equivalent network of resistors of power signal lines according to an embodiment of the present disclosure;

FIG. 4 is a structural diagram of an apparatus for driving an organic light emitting display according to an embodiment of the present disclosure;

FIG. 5 is a structural diagram of an acquisition unit in an organic light emitting display according to an embodiment of the present disclosure; and

FIG. 6 is a structural diagram of a processing unit according to an embodiment of the present disclosure.

### DETAILED DESCRIPTION OF THE EMBODIMENTS

Specific implementations of a method and apparatus for driving an organic light emitting display and an organic light emitting display according to embodiments of the present disclosure will be described in detail below in conjunction with accompanying drawings.

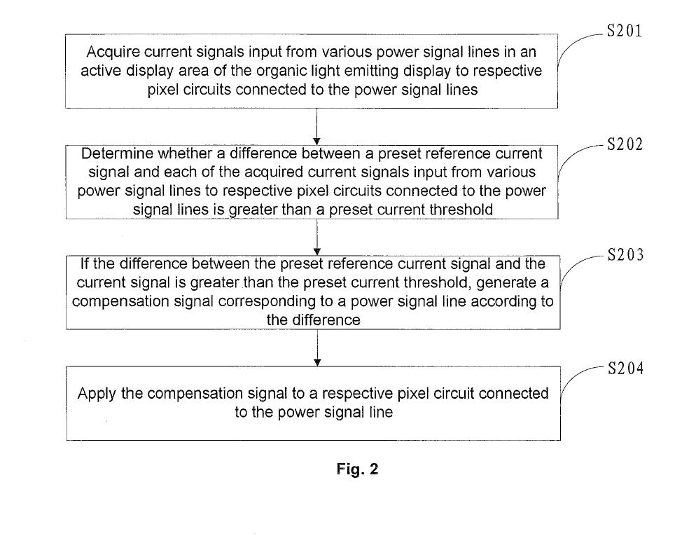

A method for driving an organic light emitting display according to an embodiment of the present disclosure will be described below with reference to FIG. 2.

Step S201: acquiring current signals input from various power signal lines in an active display area of the organic light emitting display to respective pixel circuits connected to the power signal lines.

Step S202: determining whether a difference between a preset reference current signal and each of the acquired current signals input from the power signal lines to respective pixel circuits connected to the power signal lines is greater than a preset current threshold.

Specifically, the preset current threshold may be set in a range in which grayscale jump is not generated. Of course, the current threshold may also be set to be smaller according to practical requirements, and the embodiments of the present disclosure are not limited thereto.

Step S203: if the difference between the preset reference current signal and the current signal is greater than the preset current threshold, generating a compensation signal corresponding to a respective power signal line according to the difference.

Step S204: applying the compensation signal to a pixel circuit connected to the respective power signal line.

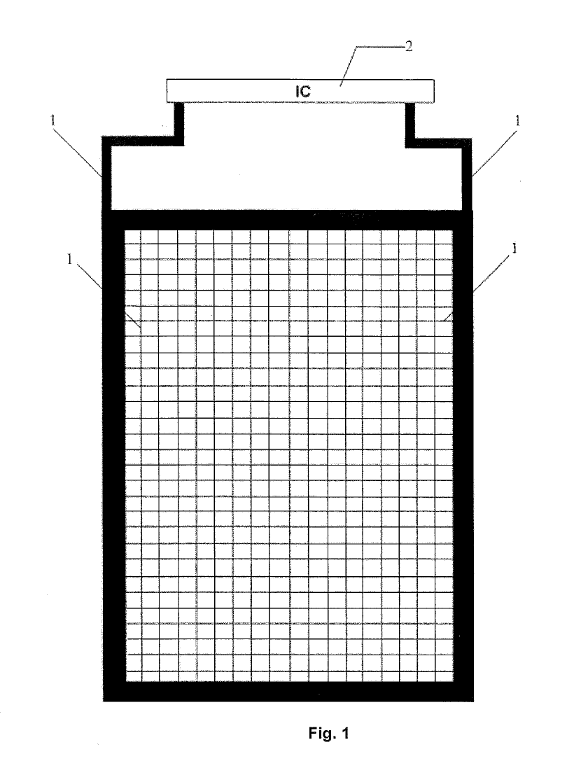

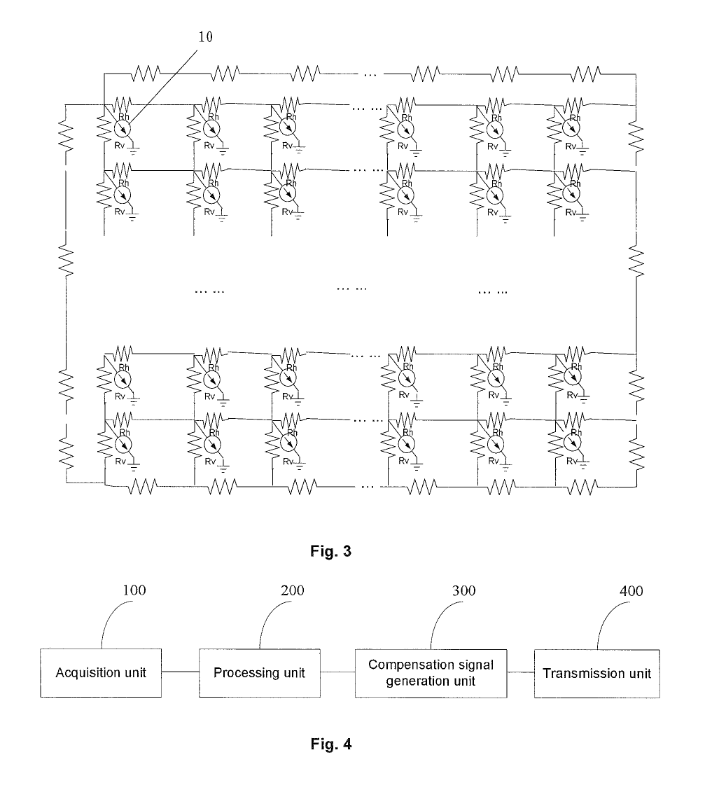

Specifically, in the above method according to an embodiment of the present disclosure, the preset reference current signal may be derived previously based on experiments. Specifically, power signal lines in the active display area of the organic light emitting display as shown in FIG. 1 may be equivalent to a network of resistors. As shown in FIG. 3, Rh is a resistor of a power signal line laterally arranged between two adjacent pixel circuits, and Rv is a resistor of a power signal line longitudinally arranged between two adjacent pixel circuits. Each pixel circuit may be equivalent to an ideal current source 10 connected in serial at an intersection between a power signal line which is laterally arranged and a power signal line which is longitudinally arranged. It can be known that when a corresponding pixel circuit emits light of particular luminance, a value of a current signal of the ideal current source is a value of a preset reference current signal corresponding to the particular luminance.

Preferably, in the above method according to an embodiment of the present disclosure, it may be determined whether a difference between a preset reference current signal and each of the acquired current signals input from the power signal lines to pixel circuits connected to the power signal lines is greater than a preset current threshold range in the following manner:

converting each of the acquired current signals input from the power signal lines to respective pixel circuits connected to the power signal lines into a voltage signal; and

determining whether a difference between a preset reference voltage signal and the voltage signal is greater than a preset voltage threshold range.

Specifically, in the above method according to an embodiment of the present disclosure, as it is more difficult to compare current signals than comparing voltage signals, each of the acquired current signals input from the power signal lines to respective pixel circuits connected to the power signal lines may be converted into a voltage signal, and then a comparison is made between voltage signals.

Preferably, in the above method according to an embodiment of the present disclosure, determining whether a difference between a preset reference voltage signal and the voltage signal is greater than a preset voltage threshold range may include:

converting the voltage signal into a digital signal; and

determining whether a difference between a preset reference digital signal and the digital signal is greater than a preset digital signal threshold.

The voltage signal is converted into a digital signal to enable a strong anti-interference capability in signal transmission.

Preferably, the above method according to an embodiment of the present disclosure may further include:

converting the difference between the preset reference voltage signal and the voltage signal into a digital signal.

Preferably, in the above method according to an embodiment of the present disclosure, a compensation signal corresponding to the power signal line may be generated according to the difference in the following manner:

selecting a compensation signal corresponding to the difference from a pre-stored compensation signal mapping relationship table.

Preferably, current signals input from the power signal lines in the active display area of the organic light emitting display to respective pixel circuits connected to the power signal lines may be acquired in the following manner:

when the organic light emitting display is started and/or in an interval between display of two frames of images on the organic light emitting display, acquiring the current signals input from the power signal lines in the active display area of the organic light emitting display to respective pixel circuits connected to the power signal lines.

The above method for driving an organic light emitting display according to an embodiment of the present disclosure will be described in detail below by way of several examples.

### First Example

A method for driving an organic light emitting display may include the following steps:

(1) acquiring current signals input from the power signal lines in an active display area of the organic light emitting display to respective pixel circuits connected to the power signal lines;

(2) determining whether a difference between a preset reference current signal and each of the acquired current signals input from the power signal lines to respective pixel circuits connected to the power signal lines is greater than a preset current threshold;

(3) if the difference between the preset reference current signal and the current signal is greater than the preset current threshold, selecting a compensation signal corresponding to the difference from a pre-stored compensation signal mapping relationship table; and

(4) applying the compensation signal to a respective pixel circuit connected to the power signal line.

Specifically, in the first example, the acquired current signal is directly compared with the preset reference current signal. In practice, as the comparison between current signals is relatively complex, the current signal may be converted into a voltage signal, and the voltage signal is then compared with a preset voltage signal, as described in second and third examples.

### Second Example

A method for driving an organic light emitting display may include the following steps:

(1) acquiring current signals input from the power signal lines in an active display area of the organic light emitting display to respective pixel circuits connected to the power signal lines;

(2) converting each of the acquired current signal input from the power signal lines to respective pixel circuits connected to the power signal lines into a voltage signal;

(3) determining whether a difference between a preset reference voltage signal and the voltage signal is greater than a preset voltage threshold;

(4) if the difference between the preset reference voltage signal and the voltage signal is greater than the preset voltage threshold, converting the difference between the preset reference voltage signal and the voltage signal into a digital signal; and

(5) selecting a compensation signal corresponding to the difference from a pre-stored compensation signal mapping relationship table;

(6) applying the compensation signal to a respective pixel circuit connected to the power signal line.

### Third Example

A method for driving an organic light emitting display includes the following steps:

(1) acquiring current signals input from the power signal lines in an active display area of the organic light emitting display to respective pixel circuits connected to the power signal lines;

(2) converting each of the acquired current signals input from the power signal lines to respective pixel circuits connected to the power signal lines into a voltage signal;

(3) converting the voltage signal into a digital signal;

(4) determining whether a difference between a preset reference digital signal and the digital signal is greater than a preset digital signal threshold;

(5) if the difference between the preset reference digital signal and the digital signal is greater than the preset digital signal threshold, selecting a compensation signal corresponding to the difference from a pre-stored compensation signal mapping relationship table;

(6) applying the compensation signal to a respective pixel circuit connected to the power signal line.

As shown in FIG. 4, in the embodiments of the present disclosure, an apparatus for driving an organic light emitting display is further provided, including:

an acquisition unit 100 configured to acquire current signals input from the power signal lines in an active display area of the organic light emitting display to respective pixel circuits connected to the power signal lines;

a processing unit 200 configured to determine whether a difference between a preset reference current signal and each of the acquired current signals input from the power signal lines to respective pixel circuits connected to the power signal lines is greater than a preset current threshold;

a compensation signal generation unit 300 configured to generate a compensation signal corresponding to the power signal line according to the difference if the difference between the preset reference current signal and the current signal is greater than the preset current threshold; and

a transmission unit 400 configured to apply the compensation signal to a respective pixel circuit connected to the power signal line.

Specifically, in order to improve compensation accuracy, one acquisition unit may correspond to one pixel circuit connected to a power signal line, thereby compensating for each pixel circuit in the active display area of the organic light emitting display. However, it will increase complexity of the preparation process and a cost of production. Therefore, one acquisition unit may correspond to a column of pixel circuits connected to a power signal line or a row of pixel circuits connected to a power signal line. Of course, one acquisition unit may also correspond to multiple columns or rows of pixel circuits connected to power signal lines. The embodiments of the present disclosure are not limited thereto.

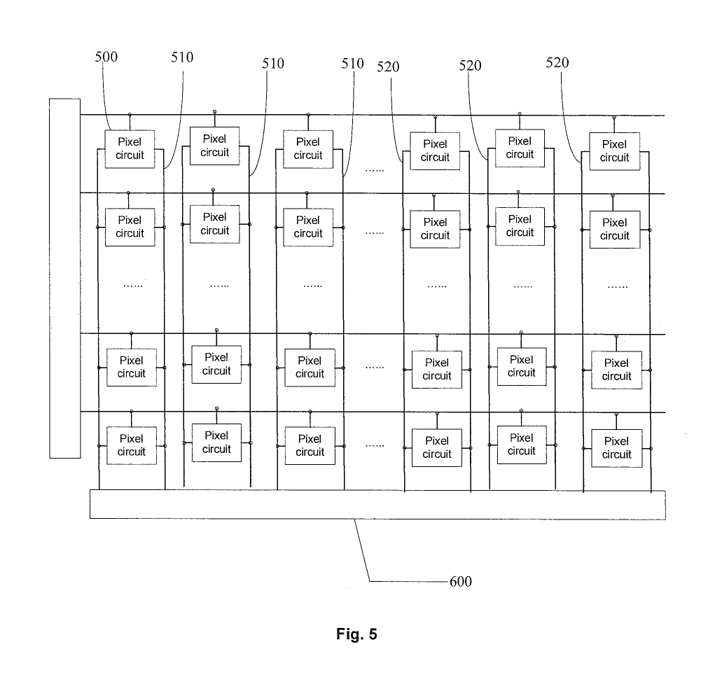

Preferably, the acquisition unit may be implemented on a backboard chip 600 of the organic light emitting display, and each column of pixel circuits connected to a power signal line corresponds to one acquisition unit. As shown in FIG. 5, the acquisition units implemented on the backboard chip 600 are electrically connected to the columns of pixel circuits 500 via sampling signal lines 510, to acquire current signals input from the power signal lines to the columns of pixel circuits 500. Specifically, the sampling signal lines 510 may be arranged in the same layer as data lines 520.

Further, as structures of the processing unit and the compensation signal generation unit are generally complex, the processing unit, the compensation signal generation unit and the transmission unit are arranged in a peripheral circuit of the organic light emitting display.

Further, the transmission unit may apply compensation signals to the pixel circuits connected to the power signal lines via the sampling signal lines. Of course, the transmission unit may also apply the compensation signals to the pixel circuits connected to the power signal lines via signal lines which are additionally arranged. The embodiments of the present disclosure are not limited thereto.

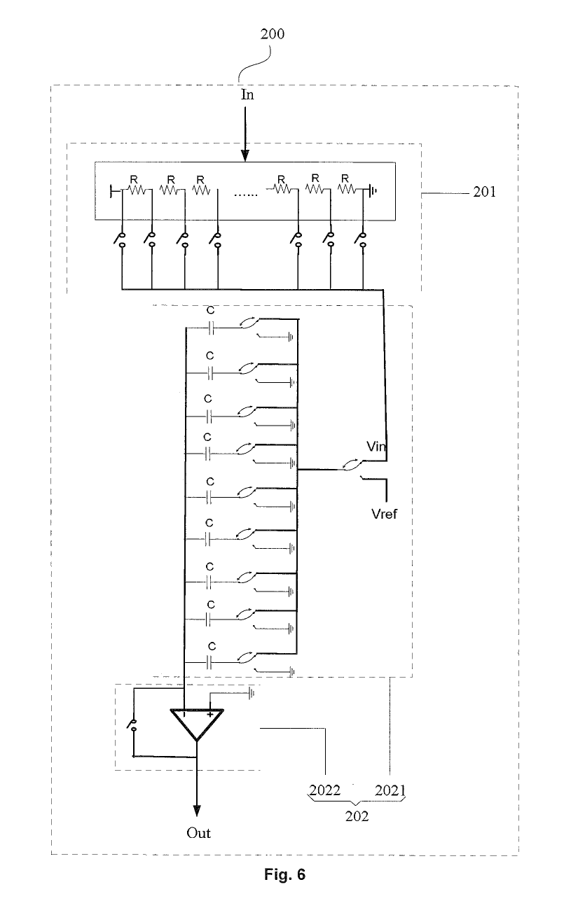

Preferably, as shown in FIG. 6, the processing unit 200 may include:

a voltage conversion unit 201 configured to convert each of the acquired current signals input from the power signal lines to respective pixel circuits connected to the power signal lines into a voltage signal; and

a determination unit 202 configured to determine whether a difference between a preset reference voltage signal and the voltage signal is greater than a preset voltage threshold.

Specifically, the voltage conversion unit 201 may be comprised of a network of resistors connected in serial. As shown in FIG. 6, the voltage conversion unit 201 may include multiple resistors R connected in serial. Of course, the voltage conversion unit 201 may also be of another structure capable of implementing the solution of the present disclosure. The embodiments of the present disclosure are not limited thereto.

Preferably, as shown in FIG. 6, the determination unit 202 may include:

a first analog-digital conversion unit 2021 configured to convert the voltage signal into a digital signal; and

a determination sub-unit 2022 configured to determine whether a difference between a preset reference digital signal and the digital signal is greater than a preset digital signal threshold.

Preferably, the processing unit 200 may further include:

a second analog-digital conversion unit configured to convert the difference between the preset reference voltage signal and the voltage signal into a digital signal when it is determined that the difference between the preset reference voltage signal and the voltage signal is greater than the preset voltage threshold.

Specifically, the first analog-digital conversion unit and the second analog-digital conversion unit may be comprised of analog-digital conversion apparatuses. The analog-digital conversion apparatuses may be existing apparatuses, and will not be described here.

Specifically, as shown in FIG. 6, a structure of the first analog-digital conversion unit 2021 may include capacitors C which have different capacities and are connected in serial. Of course, the structure of the first analog-digital conversion unit may also be another structure capable of implementing the solution of the present disclosure. The embodiments of the present disclosure are not limited thereto.

Preferably, the compensation signal generation unit is configured to:

select a compensation signal corresponding to the difference from a pre-stored compensation signal mapping relationship table.

In the embodiments of the present disclosure, an organic light emitting display is further provided, including the above apparatus for driving an organic light emitting display according to an embodiment of the present disclosure. The organic light emitting display may include any product or part having a display function, such as a mobile phone, a tablet, a television, a display, a notebook, a digital photo frame, a navigator etc. The organic light emitting display may be implemented with respect to the above embodiments of the apparatus. The repeated parts will be omitted.

The embodiments of the present disclosure provide a method for driving an organic light emitting display, including: acquiring current signals input from the power signal lines in an active display area of the organic light emitting display to respective pixel circuits connected to the power signal lines; determining whether a difference between a preset reference signal and each of the acquired current signals input from the power signal lines to respective pixel circuits connected to the power signal lines is greater than a preset threshold; if the difference between the preset reference signal and the current signal is greater than the preset threshold, generating a compensation signal corresponding to the power signal line according to the difference; and applying the compensation signal to a respective pixel circuit connected to the power signal line.

Obviously, those skilled persons in the art can make the modifications and variations to the present disclosure without departing from the spirit and scope of the present disclosure. Therefore, these modifications and variations belong to the scope defined by the claims of the present disclosure and the equivalent technologies thereof.

What is claimed is:

1. A method for driving an organic light emitting display, comprising:
acquiring current signals input from various power signal lines in an active display area of the organic light emitting display to respective pixel circuits connected to the power signal lines;
determining whether a difference between a preset reference current signal and each of the acquired current signals input from various power signal lines to respective pixel circuits connected to the power signal lines is greater than a preset current threshold;
if the difference between the preset reference current signal and the current signal is greater than the preset current threshold, generating a compensation signal corresponding to the power signal line according to the difference; and
applying the compensation signal to a respective pixel circuit connected to the power signal line.

2. The method according to claim 1, wherein determining whether a difference between a preset reference current signal and each of the acquired current signals input from the power signal lines to respective pixel circuits connected to the power signal lines is greater than a preset current threshold comprises:
converting each of the acquired current signals input from the power signal lines to respective pixel circuits connected to the power signal lines into a voltage signal; and
determining whether a difference between a preset reference voltage signal and the voltage signal is greater than a preset voltage threshold.

3. The method according to claim 2, wherein determining whether a difference between a preset reference voltage signal and the voltage signal is greater than a preset voltage threshold comprises:
converting the voltage signal into a digital signal; and
determining whether a difference between a preset reference digital signal and the digital signal is greater than a preset digital signal threshold.

4. The method according to claim 2, further comprising: when it is determined that the difference between the preset reference voltage signal and the voltage signal is greater than the preset voltage threshold, converting the difference between the preset reference voltage signal and the voltage signal into a digital signal.

5. The method according to claim 1, wherein generating a compensation signal corresponding to the power signal line according to the difference comprises:
selecting a compensation signal corresponding to the difference from a pre-stored compensation signal mapping relationship table.

6. The method according to claim 2, wherein generating a compensation signal corresponding to the power signal line according to the difference comprises:
selecting a compensation signal corresponding to the difference from a pre-stored compensation signal mapping relationship table.

7. The method according to claim 3, wherein generating a compensation signal corresponding to the power signal line according to the difference comprises:
selecting a compensation signal corresponding to the difference from a pre-stored compensation signal mapping relationship table.

8. The method according to claim 4, wherein generating a compensation signal corresponding to the power signal line according to the difference comprises:
selecting a compensation signal corresponding to the difference from a pre-stored compensation signal mapping relationship table.

9. The method according to claim 1, wherein acquiring current signals input from the power signal lines in an active display area of the organic light emitting display to respective pixel circuits connected to the power signal lines comprises:
when the organic light emitting display is started and/or in an interval between display of two frames of images on the organic light emitting display, acquiring the current signals input from the power signal lines in the active display area of the organic light emitting display to respective pixel circuits connected to the power signal lines.

10. The method according to claim 2, wherein acquiring current signals input from the power signal lines in an active display area of the organic light emitting display to respective pixel circuits connected to the power signal lines comprises:
when the organic light emitting display is started and/or in an interval between display of two frames of images on the organic light emitting display, acquiring the current signals input from the power signal lines in the active display area of the organic light emitting display to respective pixel circuits connected to the power signal lines.

11. The method according to claim 3, wherein acquiring current signals input from the power signal lines in an active display area of the organic light emitting display to respective pixel circuits connected to the power signal lines comprises:
when the organic light emitting display is started and/or in an interval between display of two frames of images on the organic light emitting display, acquiring the current signals input from the power signal lines in the active display area of the organic light emitting display to respective pixel circuits connected to the power signal lines.

12. The method according to claim 4, wherein acquiring current signals input from the power signal lines in an active display area of the organic light emitting display to respective pixel circuits connected to the power signal lines comprises:
when the organic light emitting display is started and/or in an interval between display of two frames of images on the organic light emitting display, acquiring the current signals input from the power signal lines in the active display area of the organic light emitting display to respective pixel circuits connected to the power signal lines.

13. The method according to claim 5, wherein acquiring current signals input from the power signal lines in an active display area of the organic light emitting display to respective pixel circuits connected to the power signal lines comprises:
when the organic light emitting display is started and/or in an interval between display of two frames of images on the organic light emitting display, acquiring the current signals input from the power signal lines in the active display area of the organic light emitting display to respective pixel circuits connected to the power signal lines.

14. An apparatus for driving an organic light emitting display, comprising:
an acquisition unit configured to acquire current signals input from various power signal lines in an active display area of the organic light emitting display to respective pixel circuits connected to the power signal lines;
a processing unit configured to determine whether a difference between a preset reference current signal and each of the acquired current signals input from the power signal lines to respective pixel circuits connected to the power signal lines is greater than a preset current threshold;
a compensation signal generation unit configured to generate a compensation signal corresponding to the power signal line according to the difference if the difference between the preset reference current signal and the current signal is greater than the preset current threshold; and
a transmission unit configured to apply the compensation signal to a respective pixel circuit connected to the power signal line.

15. The apparatus according to claim 14, wherein the processing unit comprises:
a voltage conversion unit configured to convert each of the acquired current signals input from the power signal lines to respective pixel circuits connected to the power signal lines into a voltage signal; and
a determination unit configured to determine whether a difference between a preset reference voltage signal and the voltage signal is greater than a preset voltage threshold.

16. The apparatus according to claim 15, wherein the determination unit comprises:
a first analog-digital conversion unit configured to convert the voltage signal into a digital signal; and
a determination sub-unit configured to determine whether a difference between a preset reference digital signal and the digital signal is greater than a preset digital signal threshold.

17. The apparatus according to claim 15, wherein the processing unit further comprises:
a second analog-digital conversion unit configured to convert the difference between the preset reference voltage signal and the voltage signal into a digital signal when it is determined that the difference between the preset reference voltage signal and the voltage signal is greater than the preset voltage threshold.

18. The apparatus according to claim 17, wherein the compensation signal generation unit is configured to:
select a compensation signal corresponding to the difference from a pre-stored compensation signal mapping relationship table.

19. An organic light emitting display, comprising the apparatus according to claim 14.

20. An organic light emitting display, comprising the apparatus according to claim 15.
